(19) United States
(12) Patent Application Publication
(10) Pub. No.: US 2018/0054159 A1
(43) Pub. Date: Feb. 22, 2018

(54) LIGHT COLLECTION AND REDIRECTION TO A SOLAR PANEL

(71) Applicant: BIGZ TECH INC., Saint-Laurent (CA)

(72) Inventors: Eliot AHDOOT, Dollard-des-Ormeaux (CA); Simon AHDOOT, Toronto (CA); Benjamin AHDOOT, Dollard-des-Ormeaux (CA)

(21) Appl. No.: 15/680,552

(22) Filed: Aug. 18, 2017

Related U.S. Application Data
(60) Provisional application No. 62/377,894, filed on Aug. 22, 2016.

(51) Int. Cl. H02S 40/22

(52) U.S. Cl. CPC H02S 40/22

(57) ABSTRACT

There is provided a unit for light conversion in a building, The unit comprises a solar panel comprising photovoltaic cells without any light-absorbing or light-reflecting coating such as to be raw. The photovoltaic cells can have a wavelength range of conversion optimized for natural sunlight. The unit further comprises an enclosure surrounding the solar panel and preventing the exposure of the solar panel from direct light from outside the enclosure, the enclosure comprising an input, There is provided a light guide comprising an optical fiber and adapted for optical connection to the light collector, the light guide being connectable to the enclosure via the input, the light guide having an output end located by the input of the enclosure and directed toward a surface of the photovoltaic cells for illumination thereof. A light collector is provided outside the building for collecting sunlight and guiding the sunlight into the light guide.

### BACKGROUND

### (a) Field

The subject matter disclosed generally relates to light collection and conversion. More specifically, it relates to an enclosed solar panel system.

### (b) Related Prior Art

Sunlight is an abundant source of energy. The ability to harvest sunlight for conversion into another form of energy is useful many purposes.

The building industry is making attempts to embrace solar energy. Rooftops of buildings are evolving over time, as buildings get adapted for the installation of solar panels on top of them. These solar panels can be photovoltaic cells that convert sunlight into electric power, or solar thermal panels that collect heat from the radiation for heating water, for example.

Retrofitting existing buildings to meet such needs can be difficult. Changing the location and orientation of a building to modify its exposure to sunlight is impossible. Modifying architectural elements of the building to integrate solar panels may not be feasible or may be impractical from an architectural point of view.

Furthermore, the addition of solar panels on the rooftop requires the roof to have access for maintenance staff and available space for the solar panels, a requirement that is worsened by the fact solar panels are usually inclined (i.e., they require a greater surface area) and require space in-between for the circulation of maintenance staff. Moreover, the roof must be able to withstand the significant weight of the solar panels.

### SUMMARY

According to an embodiment, there is provided a unit for light conversion in a building, the unit comprising:
a solar panel comprising photovoltaic cells without any light-absorbing or light-reflecting coating such as to be raw, the photovoltaic cells having a wavelength range of conversion optimized for natural sunlight;
an enclosure surrounding the solar panel and preventing the exposure of the solar panel from direct light from outside the enclosure, the enclosure comprising an input; and
a light guide comprising an optical fiber and adapted for optical connection to the light collector, the light guide being connectable to the enclosure via the input, the light guide having an output end located by the input of the enclosure and directed toward a surface of the photovoltaic cells for illumination thereof; and
a light collector located outside the building for collecting natural sunlight and substantially guiding the natural sunlight into the light guide, the light collector comprising a concave portion for light collection, the concave portion being one of a dish and a reflector of a lamp.

According to another embodiment, there is provided unit for light conversion receiving light from a light collector, the unit comprising:
a solar panel comprising photovoltaic cells without any light-absorbing or light-reflecting coating such as to be raw;
an enclosure surrounding the solar panel and preventing the exposure of the solar panel from direct light from outside the enclosure, the enclosure comprising an input; and
a light guide adapted for optical connection to the light collector located outside the enclosure, the light guide being connectable to the enclosure via the input.

According to another embodiment, there is provided unit for light conversion, the unit comprising:
a solar panel comprising uncoated photovoltaic cells; and
an enclosure surrounding the solar panel and comprising an input for a light guide connectable to the enclosure via the input.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a picture illustrating a sunlight harnessing system, according to the prior art;

FIG. 2 is a side view of a system comprising a light collector feeding a solar panel in an enclosure, according to an embodiment;

FIG. 3 is a picture showing a perspective view of a light collector, according to an embodiment;

FIG. 4 is a cross-section of a light collector with incoming light rays being reflected to a focal point, according to an embodiment;

FIG. 5 is a side view of a light capturing element with incoming light rays being reflected therein and captured, according to an embodiment; and

FIG. 6 is a side view of a light collector with a light capturing element installed at a focal spot therein and a light guide extending therefrom, according to an embodiment;

FIG. 7 is a side view of a system comprising a plurality of light collectors feeding a plurality of enclosed solar panels installed side-by-side, according to an embodiment;

FIG. 8 is a side view of a system comprising a plurality of light collectors feeding a plurality of piled-up enclosed solar panels, according to an embodiment;

FIG. 9 is a side view of a system comprising a plurality of light collectors feeding a plurality of piled-up enclosed solar panels, according to another embodiment;

FIG. 10 is a side view of a system comprising a plurality of light collectors feeding a plurality of piled-up enclosed solar panels and a lighting device, according to an embodiment;

FIG. 11 is a side view of an enclosure comprising a solar panel with a lens system, according to an embodiment;

FIG. 12 is a side view of a system comprising rooftop light collectors feeding enclosed solar panels in a building, according to an embodiment; and

FIG. 13 is a side view of another embodiment of a light collector to be used in the system, according to an embodiment.

It will be noted that throughout the appended drawings, like features are identified by like reference numerals.

### DETAILED DESCRIPTION

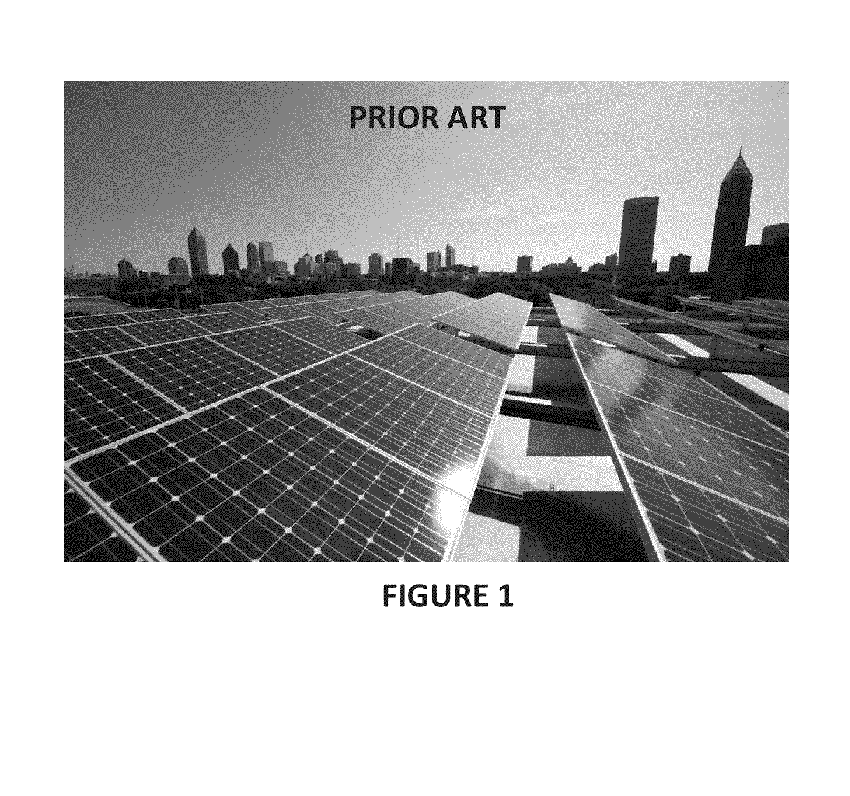

Referring to FIG. 1, there is shown a prior art system for harnessing solar energy. FIG. 1 is a picture of a real life system comprising solar panels on the rooftop of a building. On the picture, it is apparent that the real-life solar panels are bulky. The bulkiness is even worsened by the inclination of the solar panels, which is a common feature of solar panels installations in regions of middle to high latitude because it is preferable if solar panels are perpendicular to the incoming sunlight, and the Sun has an inclination in the sky. A walkable surface for maintenance access is also shown in FIG. 1.

This configuration has been determined as requiring too much surface area on the rooftop, and requiring reinforcement of the rooftop structure. This is therefore not convenient, and retrofitting for installing solar panels is hard and costly.

Furthermore, the solar panels are exposed to weather and other environmental conditions that require maintenance (dust accumulation, exposition to various debris, degradation of materials). These environmental conditions further require the photovoltaic cells of the solar panels to be protected by a coating because the raw (i.e., naked) photovoltaic cells cannot withstand these environmental conditions.

The coating over the raw photovoltaic cells has the undesirable effect of absorbing and reflecting a fraction of the incoming light, thereby reducing the overall performance of the coated solar panel compared to an uncoated one.

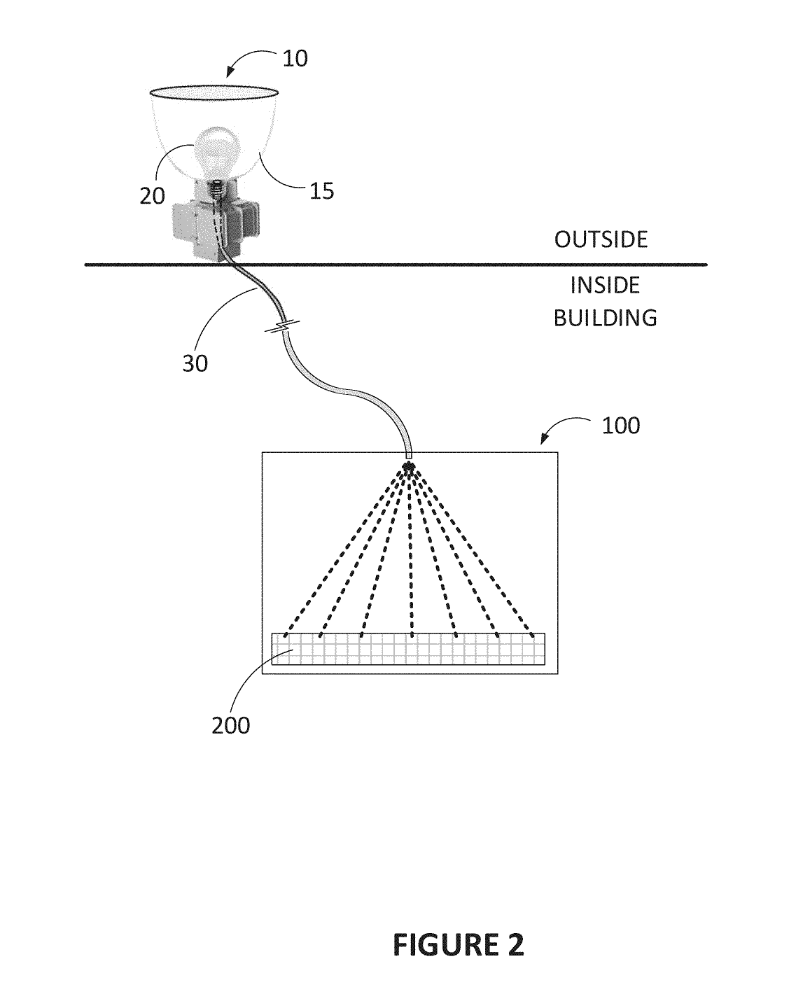

According to an embodiment, the solar panel 200 comprising photovoltaic cells is provided in a location where the weather and other damageable environmental conditions are substantially absent. According to an embodiment, the solar panel 200 is provided in an enclosure 100, as shown in FIG. 2, which acts as a protection against such potentially damaging environmental conditions. Protective walls can be used instead of an enclosure as long as they are advantageously positioned to protect the solar panel from dust, debris and the like. However, portability (for easy transport) is less likely to be ensured by protective walls than if an enclosure 100 is used. Indeed, the enclosure 100 is like a box. It can therefore be handled by someone and displaced where needed.

Protecting the solar panel by providing a protective enclosure 100 or any similar barrier makes possible the removal of the coating on the photovoltaic cells since the risk of damaging the raw photovoltaic cells is greatly reduced by providing the enclosure or walls. Therefore, according to an embodiment, the solar panel 200 is provided with raw photovoltaic cells (i.e., they have no coating). The performance of solar panel 200 is thereby increased, thereby mitigating the other losses that may result from guiding light from a collector to an enclosure, as described below.

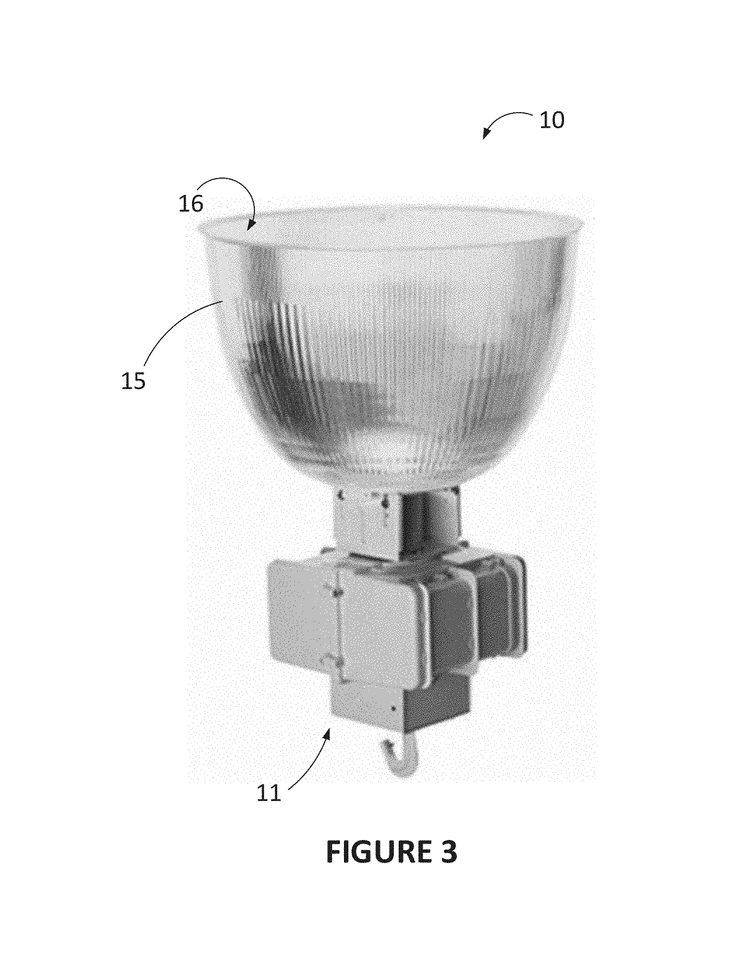

Providing such an enclosure 100 or walls blocks incoming sunlight, since the barrier for precipitation, dust, debris and the like also acts as a barrier for sunlight. Moreover, one of the advantages of installing a solar panel in an enclosure lies in the possibility of installing the enclosure at an arbitrary location, for example at a convenient location in a building. Therefore, there is a need for a light collector that would collect and redirect incoming sunlight toward the inside of the enclosure where it can be received by the solar panel. Referring to FIG. 3, there is shown an embodiment of a light collector 10.

According to an embodiment, the light collector 10 is designed to facilitate the retrofitting into existing buildings, i.e., the materials required to build the light collector 10 and its dimensions do not cause the light collector 10 to have excessive weight. The light collector 10 can be fabricated in small-weight versions that can be installed on rooftops without alterations to the roof structure to improve the weight-supporting capacity. The light collector 10 does not need to be inclined in order to have a satisfying performance.

Furthermore, as will be realized below, the functionality of redirecting light rather than concentrating it allows for a greater versatility in the user of the light collector 10. The light collector 10 can be used to transmit the light elsewhere in the building for lighting purposes, without any conversion, because light guides can be used to split the optical power into various guides that can then be routed to various locations for different applications.

FIG. 3 shows an exemplary light collector 10 that can be modular, like the enclosures 100. The light collector 10 of FIG. 3 comprises a concave portion 15. The concave portion 15 has a bowl shape and defines an inner surface 16 and an outer surface 17. The inner surface 16 needs to be reflective.

To provide a reflective inner surface 16, a reflective coating, made of an optically-reflective material, can be provided on the inner surface 16. Since the concave portion 15 is intended to substantially focus light, i.e., to bring light toward an approximate location, a substantially specular reflection is preferred over diffuse reflection. Preferably, the optically-reflective material should be selected to meet this requirement.

The term “optically-reflective” is intended to mean that relevant wavelength ranges are substantially reflected. Different wavelength ranges are expected to be reflected with different efficiencies (i.e., different percentages of reflection). The percentage that is not reflected is usually absorbed by the inner surface 16; this situation is usually undesirable, and therefore higher percentages of reflection are most often desired. In some circumstances, only certain/selected optical wavelengths are desired (wavelength ranges that are well converted by photovoltaic cells) while others are undesirable (e.g., infrared that only dissipate into heat, or other wavelength ranges that are not converted by photovoltaic cells and heat them, thereby decreasing their performance). These other undesirable wavelength ranges can be substantially cut off by providing a selective reflective coating. This configuration removes the undesirable (e.g., infrared) radiations from the radiations transmitted into the building, thereby preventing a major cause of heating in the building.

A light guide 30 is used for guiding the light collected by the light collector 10 toward the enclosure 100 containing the solar panel 200. The light guide 30 transmits light radiation on a certain distance, usually through a material (e.g., when the light guide 30 is an optical fiber). This material has optical properties including a coefficient of absorption, which is a function of the wavelength. Some wavelengths travel better than others (i.e., some wavelengths have higher percentages of transmission than others) in the light guide's material. The reflective properties of the inner surface 16 should therefore match the transmission properties of the light guide 30 to make sure that desirable wavelengths are both reflected in a suitably high percentage by the inner surface 16 and transmitted in a suitably high percentage by the light guide 30. If there are provided other optical parts (e.g., lenses, mirrors, couplers, multiplexers, etc.) with which light interacts, the same principle of consistency applies. If only specific wavelength ranges are transmitted with high efficiency, solar panels with photovoltaic cells that have greater efficiency with the wavelength ranges can be used.

As mentioned above, the concave portion 15 is used to substantially focus light toward a given point or spot. The concave portion 15 is concave because the concavity allows the focusing of incoming light. The concave portion 15 can have a paraboloid inner surface 16 (a paraboloid is the shape created by a rotating parabola), the optical properties of the paraboloid being known to those skilled in optical technologies. Most interestingly, light rays incoming in a line parallel with the axis of the paraboloid are focused to the focal point of the paraboloid. If light rays are not parallel to the axis, they end up being focused at other points which together define the focal plane of the paraboloid.

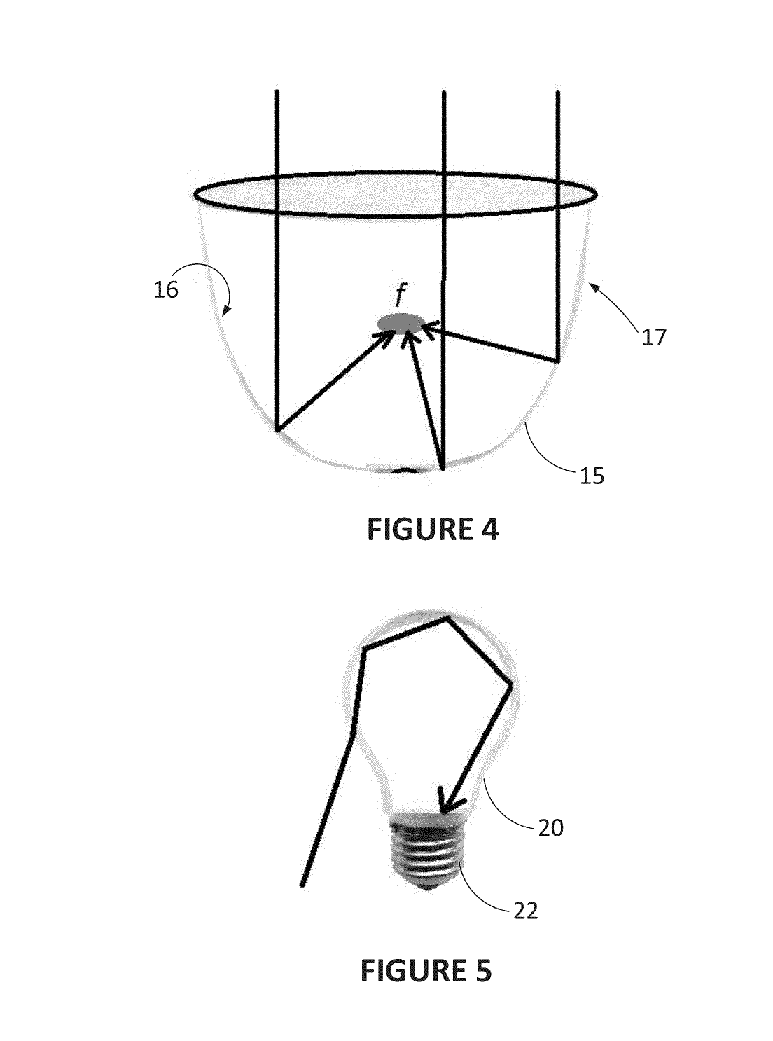

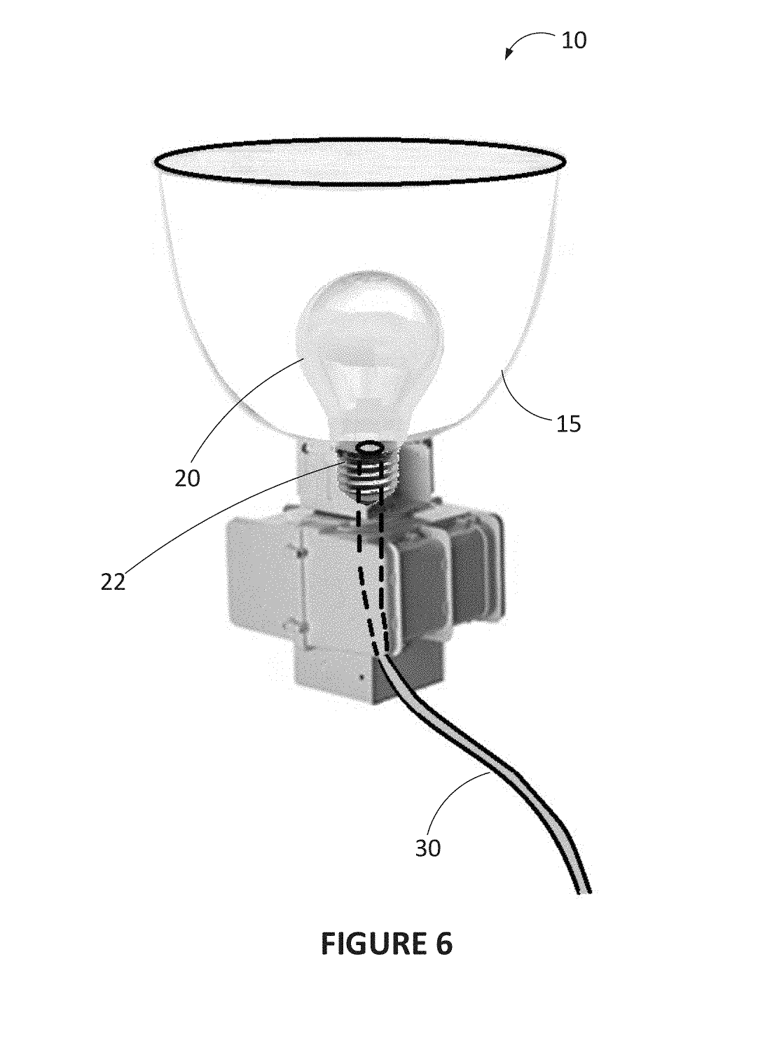

A light capturing element 20, illustrated in FIG. 5, is provided within the concavity of the concave portion (or slightly outside thereof), at or closed to the focal point, as shown in FIG. 6. The light capturing element 20 occupies some volume in space (i.e., it is not a mere point) and therefore it occupies some space around the focal point. That focal sport f is shown in FIG. 4. Preferably, the light capturing element 20 extends along some portion of the focal plane.

The light capturing element 20 needs to comprise a light transmitting surface, such as glass, in order to effectively capture incoming and focused light. A substantial ball shape is a suitable shape that occupies space around the focal sport and that can capture light.

According to an embodiment, the light capturing element 20 is the envelope of a light bulb (i.e., the glass forming the bulb), as shown in FIGS. 5-6.

The light capturing element 20 needs a support 22 so it can stand and remain at the desired location (the focal sport), which is usually a floating point above the bottom of the concave portion 15. Strings or thin rods can be provided at an upper edge of the concave portion for holding the light capturing element 20 in suspension above the bottom of the concave portion 15, at the focal spot.

In a preferred embodiment, the support 22 is a lightbulb socket, as shown in FIGS. 5-6. It means that the light capturing element 20 is a lightbulb having both the glass bulb and its supporting socket. In comparison with a standard lightbulb, this embodiment has the filament removed.

In this embodiment, the support 22, which is a lightbulb socket, can be screwed, mounted (e.g., using a bayonet mount), pinned, or otherwise held in place at the bottom of the concave portion 15. A recess can be provided at the bottom of the concave portion 15 for mounting the support 22. The length of the support 22 and/or of the light capturing element 20 should be adjusted or selected so that the light capturing element 20 is high enough to be located at the focal spot.

As shown in FIG. 5, the light capturing element 20 has a shape adapted for capturing or retaining incoming light rays. Light rays refract while entering the glass or other material forming the light capturing element 20. They refract again inside the light capturing element 20 (which is shown as being hollow, either with a vacuum inside or air). If the index of refraction of the glass or other material forming the light capturing element 20 is in the right range, most of the light rays inside the light capturing element 20 undergo total internal reflection instead of transmission and refraction outside the light capturing element 20. If all interactions of the light rays inside the light capturing element 20 are total internal reflections, the light rays are captured inside the light capturing element 20. Some coatings, fillings and other materials with different indices of refraction can be added in the light capturing element 20 to ensure that the total internal reflections are occurring as needed. When a light ray reaches the bottom of the light capturing element 20, it can be collected by the light guide for transmission elsewhere. An example of a capture of a light ray is shown in FIG. 5.

By providing a light guide 30 such as an optical fiber that starts in the bottom of the light capturing element 20, captured light rays can enter the light guide 30 by one of its ends and travel therethrough to another location within the building where it is optically connected to the enclosure 100. A light guide 30 extending from the bottom of the light capturing element 20 and being routed out from the light collector 10 is shown in FIG. 6.

The resulting light collector 10 is therefore very compact. It does not weigh more than small objects being brought up temporarily on a rooftop and therefore, no structural solidifications are required to install the light collector 10 on a building's rooftop. Furthermore, the light collector 10, in an embodiment, can advantageously be built from existing objects that are widely available and rather inexpensive in comparison with usual components of sunlight harnessing technologies.

For example, there exist many types of lamps having a reflector with the same shape as the light collector 10 illustrated in FIG. 3. The reflectors also have a socket adapted for receiving a lightbulb. Therefore, the light collector 10 can be manufactured by providing a reflector of a lamp and a lightbulb. The lightbulb can be built without the filament and with an aperture provided at the bottom of its metallic socket. An optical fiber can be inserted into the bottom aperture of the lightbulb and secured therein (with adhesive or mechanical fixation means), while extending from the lightbulb for light transmission. The light collector 10 thus manufactured can be mounted on a support 11 for installation at a location where there is light, such as a rooftop. The light guide 30 is extending into the space under the roof (e.g., in the attic) and can be used for guiding elsewhere. A coupler (not shown) may be used to connect another light guide for further guiding.

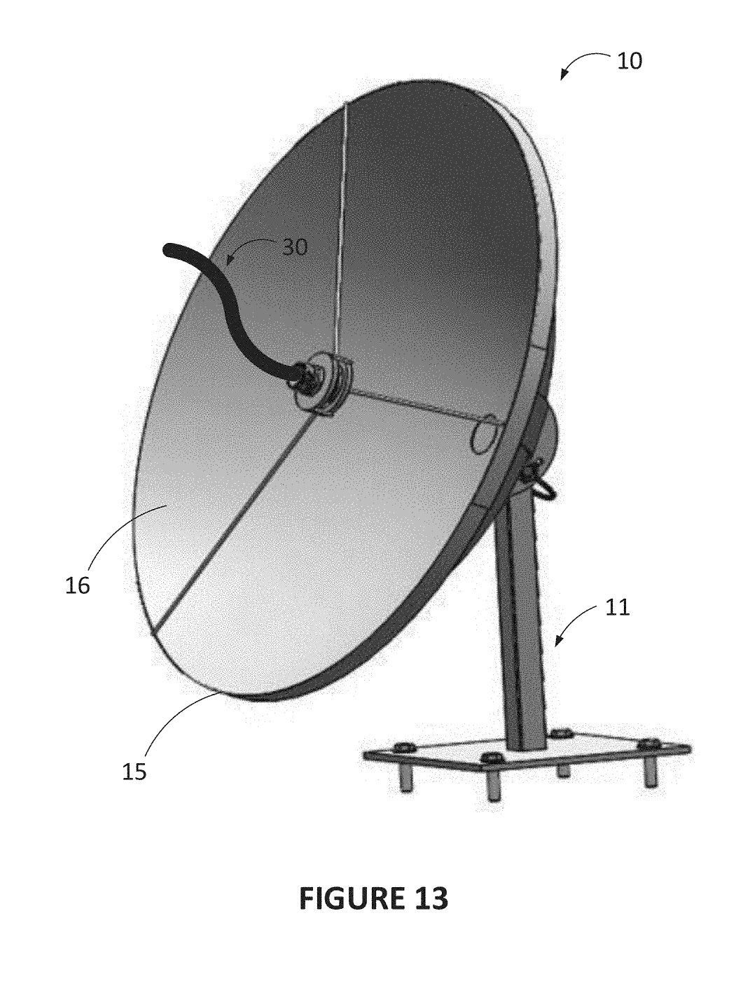

FIG. 13 shows another exemplary embodiment of a light collector 10, where the inner surface 16 of the concave portion 15 is a dish installed on a support 11, where the light guide 30 has its light-receiving end at the focal spot of the light collector 10.

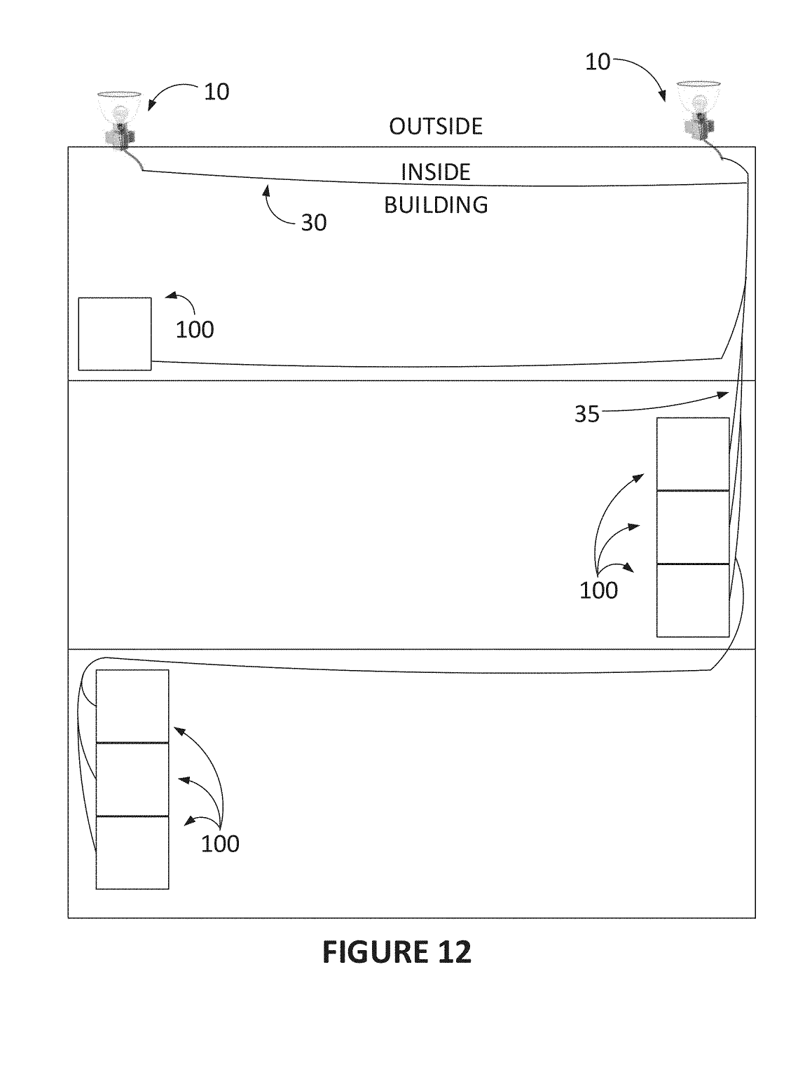

The guided light can be used for conversion to electricity by a photovoltaic cell of the solar panel 200, or for lighting (general lighting, task lighting, etc.), heating, etc. The lighting, heating and conversion to electricity can be performed anywhere permitted by the length of the light guide, usually inside the building, as shown in FIG. 12.

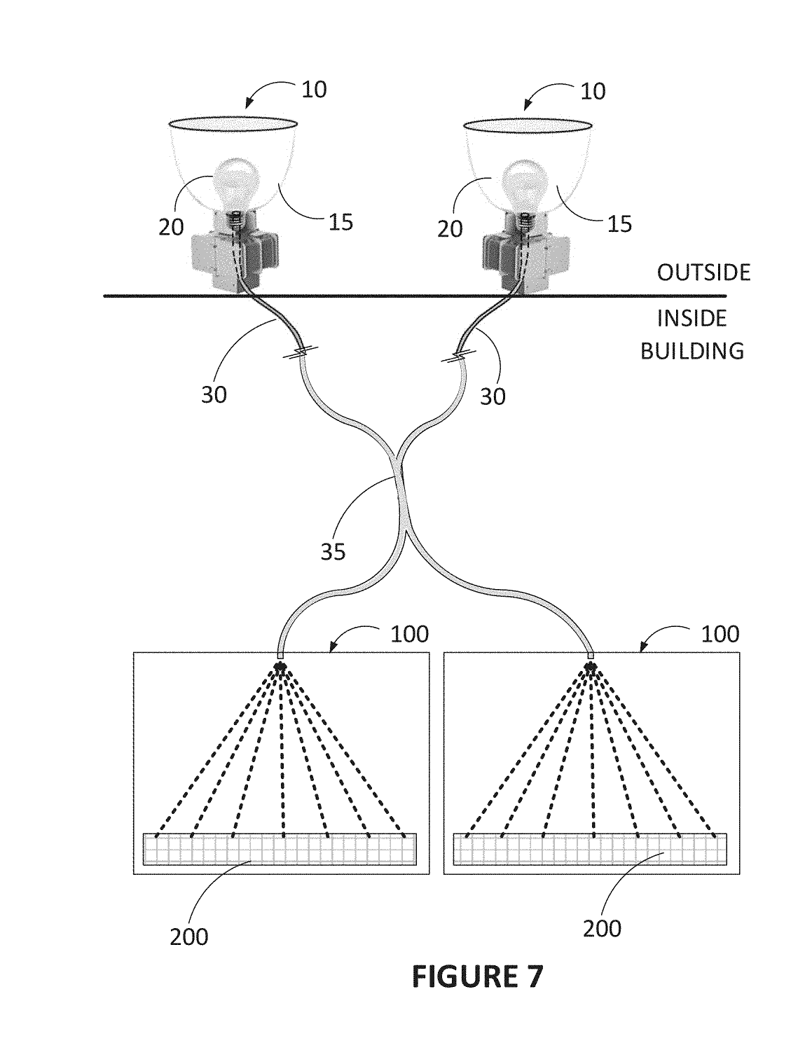

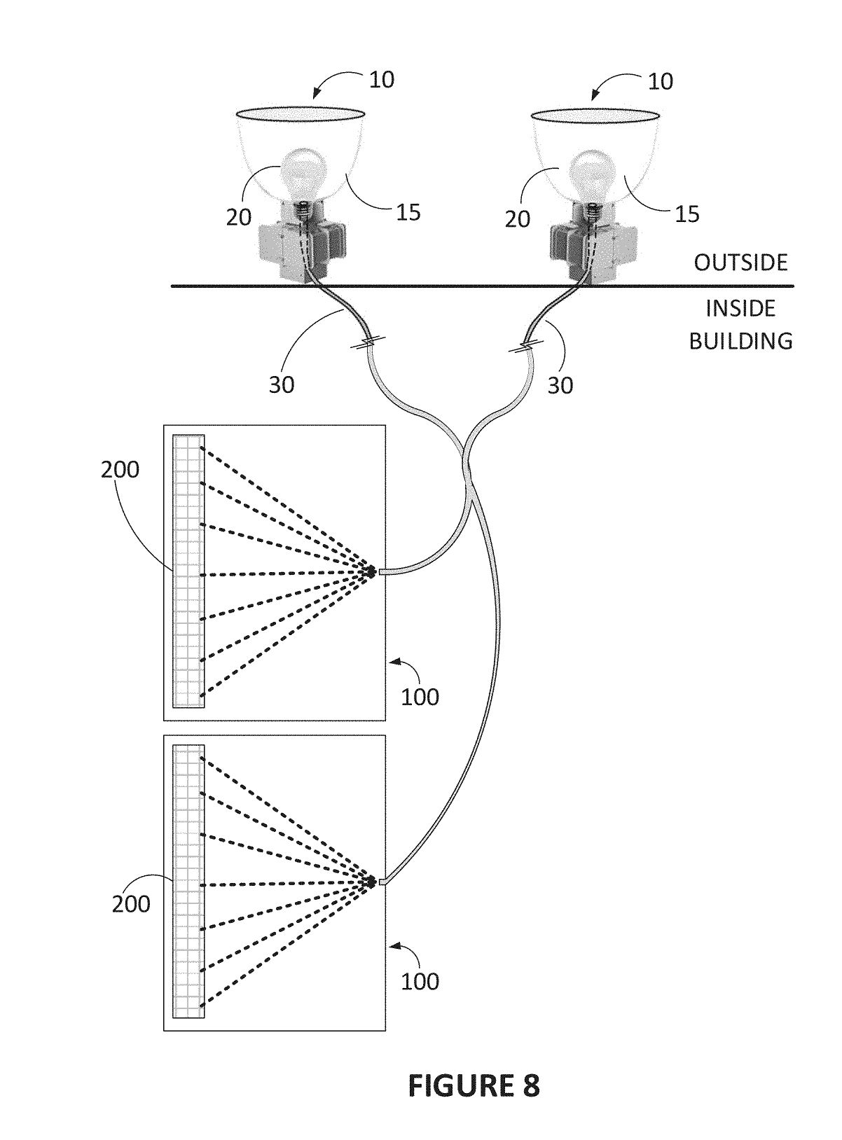

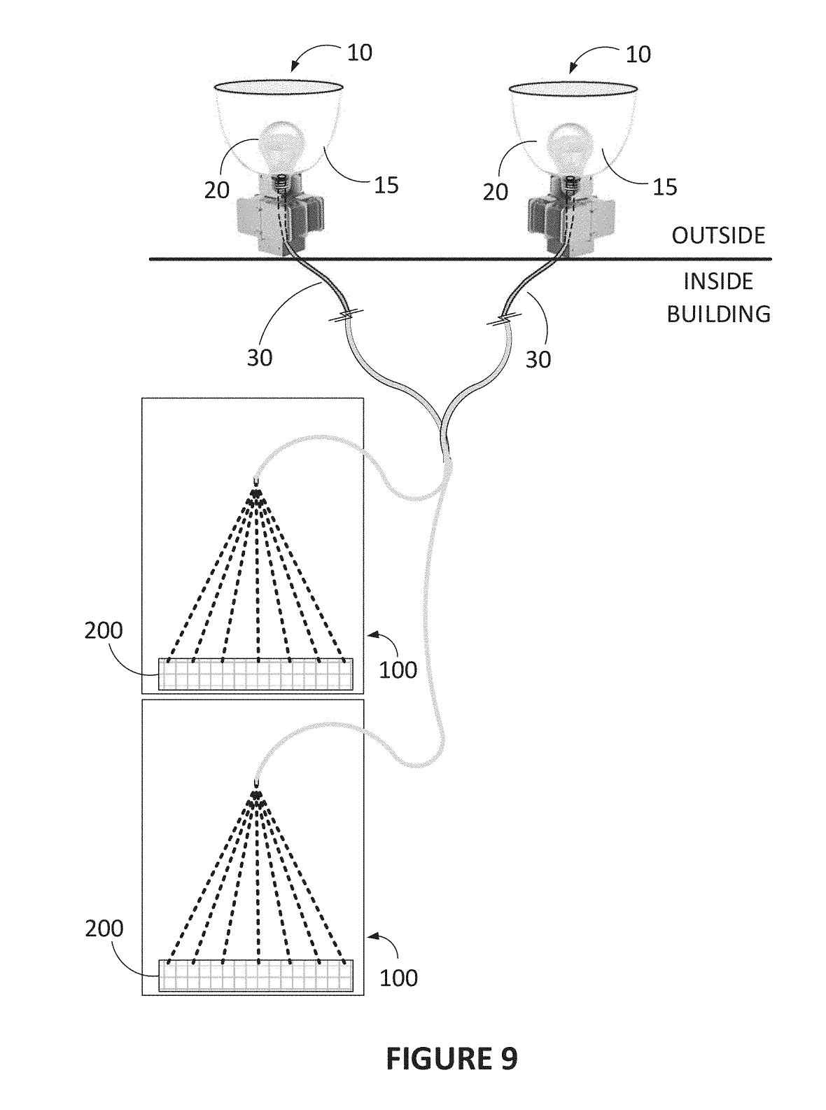

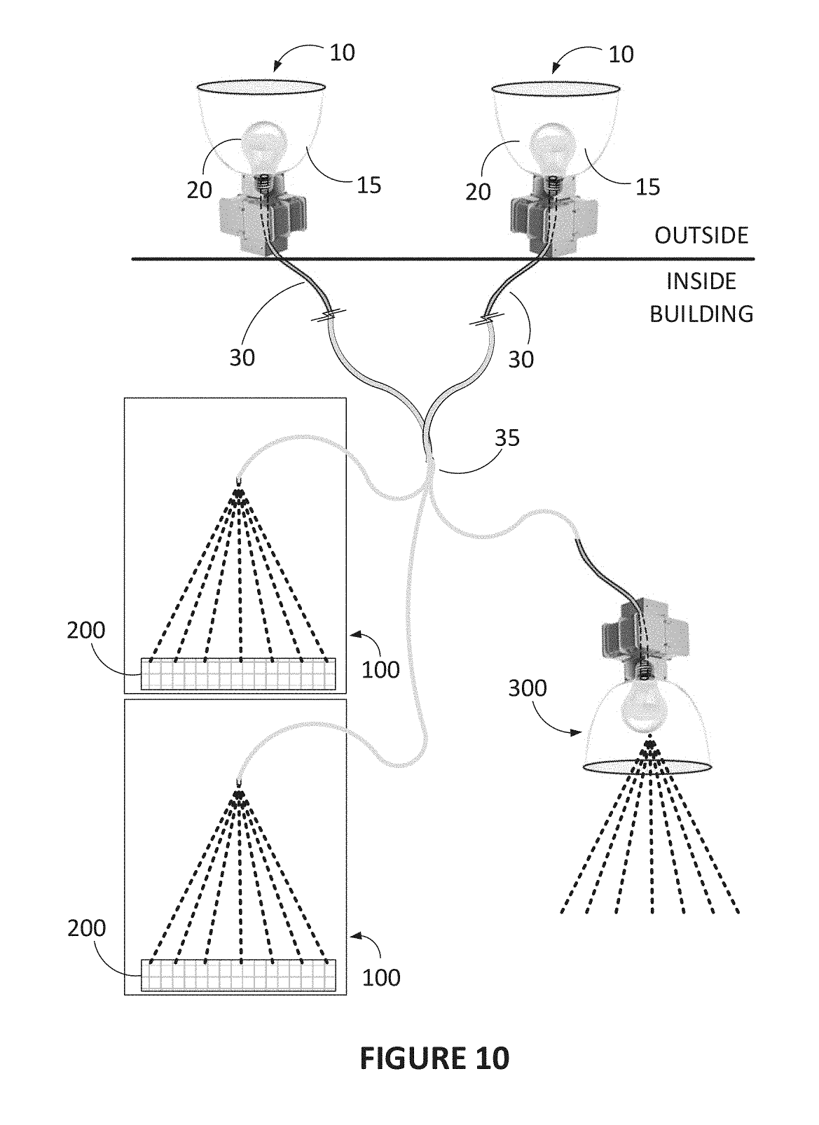

FIGS. 7-10 show that an arbitrary number of light collectors 10 can be used with an arbitrary number of applications, for example, an arbitrary number of enclosed solar panels 200. They can also be installed side-by-side (FIG. 7), piled up (FIGS. 8-10), and/or scattered over an area, e.g., on different floors of a building (FIG. 12). This arbitrary number of light collectors 10 is permitted by the modular nature of the light collectors, and the arbitrary number of enclosed solar panels 200 is permitted by the modular nature thereof. The light guides 30 and/or the bundle 35 of a plurality of light guides 30 ensure the optical connection between the light collectors 10, on one side, and the enclosed solar panels 200 on the other side. Applications different from solar panels 200 can also be provided at the application end of the system, for example lighting, as shown in FIG. 10 where the applications optically connected to the light collectors 10 via light guides 30 are heterogeneous.

If a plurality of light collectors 10 and a plurality of applications such as enclosed solar panels 200 are used, they can be either connected directed directly from one to another, as shown in FIG. 2, or can be connected via a bundle 35 of light guides 30. The bundle 35 may comprise light guides 30 fastened together to form a bundle, or merged together to form one larger light guide than can be split at a downstream location into a plurality of light guides for delivering light into applications.

This configuration ensures that the whole system can be modular at both levels: collection and conversion. As shown in FIG. 12, the light collectors 10 and the solar panels in their enclosures 100 are both disseminated respectively on and in the building according to the available space. Any convenient configuration of light collectors 10 and the solar panels in their enclosures 100 can be contemplated. The enclosures 100 containing the solar panels 200 are shown inside a building but can be elsewhere since the enclosures form a self-contained unit that can be displaced and still be used as long as it is optically connected to the light guides 30 which bring light in.

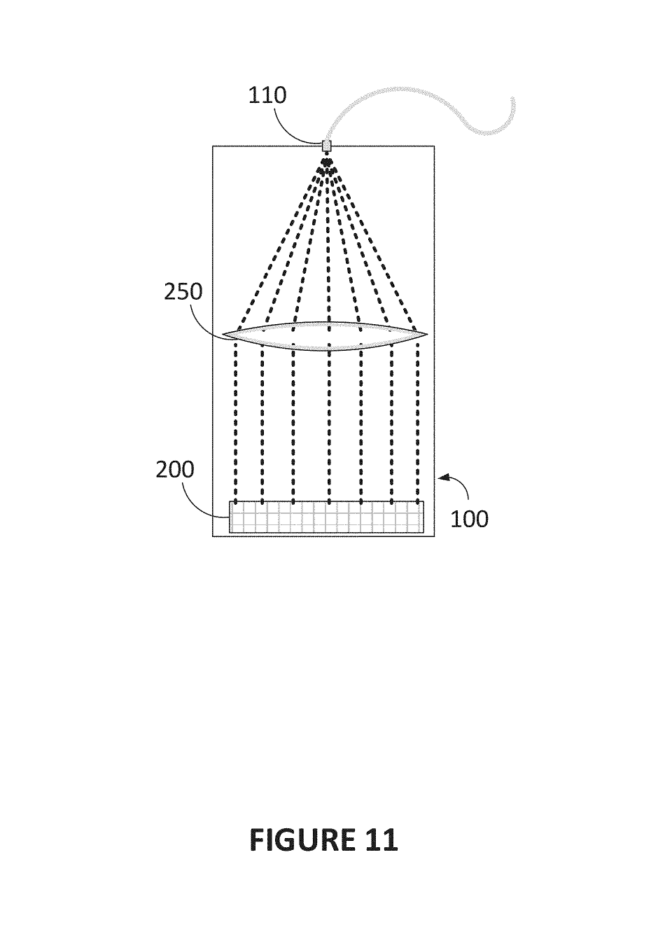

An optical connector 110 can be provided at the entrance of the enclosure 100, as shown in FIG. 11. This optical connector 110 can be mechanically coupled to the light guide 30 or bundle 35 for receiving light in the enclosure 100. For example, the optical connector 110 may comprise a snap-fit fastener cooperating with a similar piece on the end of the light guide 30, for clipping the light guide 30 into optical connector 110. In another example, it could rather comprise a screwable collet that shrinks inwardly when screwed to hold the light guide 30 in place.

FIGS. 2-10 show that the light exiting the light guide 30 into the enclosure 100 is simply emitted toward the solar panel 200. However, there may be cases when it is desirable to provide a specific light intensity profile over the area of the solar panel 200. For example, a lens system 250, which can go from very simple to very complex, can be provided inside the enclosure 100 to give a specific intensity profile to the incoming light on the solar panel 200. According to an embodiment, the lens system 250 is a convergent lens acting as a collimator to collimate the diverging light beam into a parallel light beam that is received by the solar panel in a more uniform intensity over the area of the solar panel 200.

Since the solar panel 200 is enclosed within the enclosure 100, it can be oriented arbitrarily inside the enclosure 100. If it is not provided horizontally on the bottom of the enclosure, it needs to be held firmly in place to avoid falling down using a fastener such as clips, screws, a mounting frame, adhesive or any other suitable means for fastening the solar panel 200 to the enclosure 100.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A unit for light conversion in a building, the unit comprising:
a solar panel comprising photovoltaic cells without any light-absorbing or light-reflecting coating such as to be raw, the photovoltaic cells having a wavelength range of conversion optimized for natural sunlight;
an enclosure surrounding the solar panel and preventing the exposure of the solar panel from direct light from outside the enclosure, the enclosure comprising an input; and
a light guide comprising an optical fiber and adapted for optical connection to the light collector, the light guide being connectable to the enclosure via the input, the light guide having an output end located by the input of the enclosure and directed toward a surface of the photovoltaic cells for illumination thereof; and
a light collector located outside the building for collecting natural sunlight and substantially guiding the natural sunlight into the light guide, the light collector comprising a concave portion for light collection, the concave portion being one of a dish and a reflector of a lamp.

2. A unit for light conversion receiving light from a light collector, the unit comprising:
a solar panel comprising photovoltaic cells without any light-absorbing or light-reflecting coating such as to be raw;
an enclosure surrounding the solar panel and preventing the exposure of the solar panel from direct light from outside the enclosure, the enclosure comprising an input; and
a light guide adapted for optical connection to the light collector located outside the enclosure, the light guide being connectable to the enclosure via the input.

3. A unit for light conversion, the unit comprising:
a solar panel comprising uncoated photovoltaic cells; and
an enclosure surrounding the solar panel and comprising an input for a light guide connectable to the enclosure via the input.
